(19) United States
(12) Patent Application Publication
(10) Pub. No.: US 2004/0043239 A1
(43) Pub. Date: Mar. 4, 2004

(54) Laminate and container

(76) Inventors: Toshiharu Iwasaki, Kawasaki-shi (JP); Tomohiko Ezaki, Oomachi-shi (JP); Akihiko Sakata, Kawasaki-shi (JP); Isao Otake, Kawasaki-shi (JP)

Correspondence Address: SUGHRUE MION, PLLC, 2100 PENNSYLVANIA AVENUE, N.W., WASHINGTON, DC, 20037, US

(21) Appl. No.: 10/451,884

(22) PCT Filed: Jan. 15, 2002
(86) PCT No.: PCT/JP02/00171

(30) Foreign Application Priority Data
Jan. 15, 2001 (JP) 2001-5858
Dec. 14, 2001 (JP) 2001-3820926

(51) Int. Cl. B32B 27/00

(52) U.S. Cl. 428/515; 428/500

(57) ABSTRACT

One object of the present invention is to provide a polyethylene-base resin laminate having excellent properties in the transparency, blocking resistance, flexibility and the like, exhibiting heat resistance high enough to withstand a sterilization at 121° C., and being greatly improved in the impact strength of seal part as compared with conventional laminates; in order to achieve the object, the present invention provide a laminate having at least an inner layer, an intermediate layer and an outer layer, wherein said inner layer comprises a resin material (A) containing a high-density polyethylene, said intermediate layer comprises a resin material (B) mainly comprising Polyethylene-Base Resin I which is an ethylene•α-olefin copolymer obtained by copolymerizing ethylene with an α-olefin having from 3 to 20 carbon atoms and which has the following physical properties (a) to (d), and said outer layer comprises a resin material (c) containing a high-density polyethylene:

(a) the density is less than 0.920 g/cm³,

(b) the MFR is from 0.1 to 50 g/10 min,

(c) the amount X (% by mass) of o-dichlorobenzene-soluble portion at 25° C., the density d (g/cm³) and the MFR (g/10 min) satisfy the following relationship:

X<9.8×10³×(0.9300−d+0.008 logMFR)²+2.0

(d) the parameter Cb of the composition distribution is from 1.08 to 2.00.

### CROSS REFERENCE TO RELATED APPLICATIONS

This application is based on Japanese Patent Applications, Nos. 2001-5858 and 2001-382096 filed in Japan and a provisional patent application in accordance with 35 USC § 119(e) No. U.S. Ser. No. 60/282,871 filed in United States of America.

### TECHNICAL FIELD

The present invention relates to a laminate and a container, which are excellent in the blocking resistance, transparency and flexibility, exhibit high seal part impact strength, and are suitable for uses as a medical container capable of filling blood, liquid medicament or the like, or as a container for retort foods. Examples of the medical container include blood bag, platelet storing bag, transfusion (liquid medicament) bag, multiple-compartment medical container (where two or more kinds of liquid medicaments are stored in separate compartments partitioned by an adhesive part and these multiple liquid medicaments are mixed in a closed state by peeling off the adhesive part on use) and artificial dialysis bag.

### BACKGROUND ART

The medical container for filling blood, liquid medicament or the like is required to have transparency for facilitating the inspection of mingling of a foreign matter or the verification of changes by the blending of a medicament, heat resistance sufficiently high to withstand a sterilization treatment, and flexibility for enabling easy discharge of liquid contents.

For the medical container or retort food container satisfying these properties, soft vinyl chloride, polyethylene-base materials such as high-pressure low density polyethylene, linear low-density polyethylene, high-density polyethylene and ethylene-vinyl acetate copolymer, and propylene-base mateials have been heretofore used. However, these have a problem, more specifically, the ethylene•vinyl acetate copolymer is low in the heat resistance, the vinyl chloride resin suffers from dissolving out of a plasticizer into the liquid medicament, the propylene is poor in the flexibility, and the high-pressure low-density polyethylene is inferior in the strength. The linear low-density polyethylene must be reduced in the density so as to satisfy the transparency or flexibility but the reduction in density incurs problems such as insufficient heat resistance or bleeding out of low molecular weight components of the resin.

In recent years, linear polyethylene materials produced using a single site-type catalyst and favored with high impact resistance and excellent transparency have been developed and the movement to apply these materials to medical or retort food containers is starting. Furthermore, a method of using these materials in combination as a two- or three-layer laminate has been proposed (see, JP-A-8-309939, JP-A-7-125738 and JP-A-8-244791 (the term “JP-A” as used herein means an “unexamined published Japanese patent application”)).

Even in these proposed laminates, however, the transparency is still insufficient, the impact strength in heat-seal part is not satisfied and the heat-seal part may be ruptured on the dropping of bag. Therefore, improvements in these properties have been demanded. Furthermore, if the material is formed by water-cooling inflation, T-die method. or the like, the obtained film or sheet has particularly smooth surface, giving rise to blocking of films or sheets with each other, and the separation of these films or sheets sometimes generates clouded flaws or the like on the surface to seriously deteriorate the outer appearance.

At present, demands for a container capable of sterilization at 121° C. are increasing and to satisfy these demands, higher heat resistance is needed.

The object of the present invention is to provide a polyethylene-base resin laminate having excellent properties in the transparency, blocking resistance, flexibility and the like, exhibiting heat resistance high enough to withstand a sterilization at 121° C., and being greatly improved in the impact strength of seal part as compared with conventional laminates. The object of the present invention includes providing a medical container, a food container and the like comprising this resin laminate.

### DISCLOSURE OF INVENTION

As a result of extensive investigations, the present inventors have found that the above-described objects can be attained by a laminate comprising a combination of an inner layer, an intermediate layer and an outer layer each composed of a specific resin material. The present invention has been accomplished based on this finding.

More specifically, the present invention provides a laminate having at least an inner layer, an intermediate layer and an outer layer, wherein

the inner layer composes a resin material (A) containing a high-density polyethylene;

the intermediate layer comprises a resin material (B) mainly comprising Polyethylene-Base Resin I which is an ethylene•α-olefin copolymer obtained by copolymerizing ethylene with an α-olefin having from 3 to 20 carbon atoms and which has the following physical properties (a) to (d):

(a) the density is less than 0.920 g/cm³,

(b) the MFR is from 0.1 to 50 g/10 min,

(c) the amount X (% by mass) of o-dichlorobenzene-soluble portion at 25° C., the density d (g/cm³) and the MFR (g/10 min) satisfy the following relationship:

X<9.8×10³×(0.9300−d+0.008 logMFR)²+2.0

(d) the parameter Cb of the composition distribution is from 1.08 to 2.00; and

the outer layer is composed of a resin material (c) containing a high-density polyethylene, and also provides a medical container constructed by the laminate.

The laminate of the present invention is preferably characterized in that the resin material (A) constituting the inner layer comprises only a high-density polyethylene.

The laminate of the present invention is preferably characterized in that the resin material (A) constituting the inner layer is a resin composition obtainable by blending a high-density polyethylene with Polyethylene-Base Resin II which is an ethylene•α-olefin copolymer obtained by copolymerizing ethylene and an α-olefin having from 3 to 20 carbon atoms and which has the following physical properties (e) to (h):

(e) the density is 0.920 to less than 0.960 g/cm³;

(f) the MFR is from 0.1 to 50 g/10 min:

(g) the amount X (% by mass) of o-dichlorobenzene-soluble portion at 25° C., the density d (g/cm³) and the MFR (g/10 min) satisfy the following relationship:

i) in the case of d-0.008 logMFR≧0.93, X<2.0

ii) in the case of d-0.008 logMFR<0.93,

X<9.8×10³×(0.9300−d+0.008 logMFR)²+2.0,

and

(h) the parameter Cb of the composition distribution is less than 2.00.

The laminate of the present invention is preferably characterized in that when the resin material (A) constituting the inner layer is a blend of a high-density polyethylene and an ethylene•α-olefin copolymer obtained by copolymerizing ethylene and an α-olefin having from 3 to 20 carbon atoms, the α-olefin is one or more members selected from the group consisting of propylene, butene-1,4-methylpentene-1, hexene-1, octene-1, decene-1 and dodecene-1.

The laminate of the present invention is preferably characterized in that in the ethylene•α-olefin copolymer constituting Polyethylene-Base Resin II, the content of α-olefin in the copolymer is 30 mol % or less.

The laminate of the present invention is preferably characterized in that the resin material (A) constituting the inner layer is a resin composition obtained by blending from 40 to 99% by mass of the high-density polyethylene and from 60 to 1% by mass of Polyethylene-Base Resin II.

The laminate of the present invention is preferably characterized in that the high-density polyethylene of the resin material (A) has an MFR of 0.1 to 20 g/10 min and a density of 0.940 to 0.970 g/cm³.

The laminate of the present invention is preferably characterized in that the resin material (B) constituting the intermediate layer comprises only Polyethylene-Base Resin I.

The laminate of the present invention is preferably characterized in that when the intermediate layer is an ethylene•α-olefin copolymer obtained by copolymerizing ethylene and an α-olefin having from 3 to 20 carbon atoms, the α-olefin is one or more members selected from the group consisting of propylene, butene-1, 4-methylpentene-1, hexene-1, octene-1, decene-1 and dodecene-1.

The laminate of the present invention is preferably characterized in that Polyethylene-Base Resin I satisfies the above-described physical properties (a) to (d) and at the same time, has the following physical properties (i) and (j):

(i) Mw/Mn is from 1.5 to 3.5,

(j) a plurality of peaks are present on the elution temperature-elution amount curve by continuous temperature rising elution fractionation (TREF).

The laminate of the present invention is preferably characterized in that the resin material (B) constituting the intermediate layer is a resin composition obtained by blending Polyethylene-Base Resin I and Polyethylene-Base Resin II.

The laminate of the present invention is preferably characterized in that the resin material (B) constituting the intermediate layer is a resin composition obtained by blending from 50 to 99% by mass of Polyethylene-Base Resin I and from 50 to 1% by mass of Polyethylene-Base Resin II.

The laminate of the present invention is preferably characterized in that the resin material (B) constituting the intermediate layer is a resin composition obtained by blending Polyethylene-Base Resin I with at least one member selected from the group consisting of high-density polyethylene, medium-density polyethylene, high-pressure low-density polyethylene, linear low-density polyethylene, polypropylene, ethylene-propylene random copolymer and ethylene-propylene block copolymer.

The laminate of the present invention is preferably characterized in that the resin material (B) constituting the intermediate layer is a resin composition obtained by blending Polyethylene-Base Resin I with a resin having the density of 0.935 g/cm³ or greater.

The laminate of the present invention is preferably characterized in that the resin material (C) constituting the outer layer comprises only a high-density polyethylene.

The laminate of the present invention is preferably characterized in that the resin material (C) constituting the outer layer is a resin composition obtained by blending a high-density polyethylene and Polyethylene-Base Resin II.

The laminate of the present invention is preferably characterized in that the resin material (C) constituting the outer layer is a resin composition obtained by blending from 95 to 5% by mass of the high-density polyethylene and from 5 to 95% by mass of Polyethylene-Base Resin II.

The laminate of the present invention is preferably characterized in that the outer layer comprises a resin material (D) composed of a heat-resistant resin material having a melting point peak temperature of 130° C. or more as measured by differential scanning calorimeter (DSC).

The laminate of the present invention is preferably characterized in that the heat-resistant resin material constituting the resin material (D) is a resin composition having blended therein at least one member selected from the group consisting of medium-density polyethylene, polypropylene, ethylene-propylene random copolymer, ethylene-propylene block copolymer, ethylene-vinyl alcohol copolymer (EVOH), polyamide such as 6-nylon and 6,6-nylon, and polyester such as polyethylene terephthalate and polybutylene terephthalate.

The laminate of the present invention is preferably characterized in that the thickness of the entire laminate is from 0.01 to 1 mm.

The laminate of the present invention is preferably characterized in that the thickness ratio among respective layers is inner layer/intermediate layer/outer layer=30 to 1/40 to 98/30 to 1 (assuming that the sum total is 100).

The laminate of the present invention is preferably characterized in that the laminate is obtained by a water-cooling co-extrusion multilayer inflation method or a co-extrusion multilayer T-die casting method.

The container of the present invention comprises any one of the above-described laminates.

The container of the present invention is preferably characterized in that at least a part of the inner layer of the laminate is heat-sealed as a heat-seal layer.

The container of the present invention is preferably characterized in that the inner layer of the laminate is worked into a bag shape by heat-sealing the inner layers at four sides as a heat seal layer.

### MODES FOR CARRYING OUT THE INVENTION

The laminate of the present invention has at least the following inner layer, intermediate layer and outer layer.

I. Inner Layer

The inner layer in the laminate of the present invention comprises a resin material (A) containing a high-density polyethylene. The resin material (A) may comprise only a high-density polyethylene but may be a resin composition obtained by blending a high-density polyethylene with Polyethylene-Base Resin II having predetermined physical properties.

(1) High-density Polyethylene

The high-density polyethylene for use in the inner layer is an ethylene homopolymer produced by a conventionally known method such as slurry method, solution method or vapor phase method, a copolymer of ethylene and an α-olefin having from 3 to 12 carbon atoms, or a mixture thereof. Specific examples of the α-olefin include propylene, butene-1, 4-methylpentene-1, hexene-1, octene-1, decene-1 and dodecene-1.

The MFR of high-density polyethylene is generally on the order of 0.1 to 20 g/10 min, preferably from 0.1 to 10 g/10 min. With an MFR in this range, the composition can have an appropriate melt tension and the film formation can be facilitated. The density is generally on the order of 0.940 to 0.970 g/cm³, preferably from 0.945 to 0.970 g/cm³. With a density in this range, the heat resistance can be advantageously maintained.

(2) Polyethylene-Base Resin II

Polyethylene-Base Resin II for use in the present invention has the following physical properties (e) to (h).

(e) Density

The density of Polyethylene-Base Resin II is from 0.920 to less than 0.960 g/cm³. If the density is less than this range, blocking disadvantageously occurs, whereas if the density exceeds this range, the flexibility decreases and this is not preferred. The density is more preferably from 0.920 to 0.950 g/cm³, still more preferably from 0.920 to 0.945 g/cm³.

(f) MFR

The MFR of Polyethylene-Base Resin II is from 0.1 to 50 g/10 min. If the MFR is less than this range, formability disadvantageously decreases, whereas if the MFR exceeds this range, the strength lowers and this is not preferred. The MFR is more preferably from 0.1 to 20 g/10 min.

(g) o-Dichlorobenzene-soluble portion at 25° C.

In Polyethylene-Base Resin II, the amount X (% by mass) of o-dichlorobenzene (hereinafter simply referred to as “ODCB”) soluble portion, the density d (g/cm³) and the MFR (g/10 min) satisfy a predetermined relationship.

Here, the ODCB-soluble portion at 25° C. is measured by the following method. In 20 ml of the ODCB, 0.5 g of a sample is heated at 135° C. for 2 hours and after the sample is completely dissolved, the solution is cooled to 25° C. This solution is left standing at 25° C. over night and then filtered by a Teflon-made filter. The filtrate is sampled and using this filtrate, the absorption peak area near the wave number of 2,925 cm⁻¹, which is an asymmetric stretching vibration of methylene, is determined by means of an infrared spectrometer. Based on the value obtained, the sample concentration is calculated from the previously prepared calibration curve. From this value, the ODCB-soluble portion at 25° C. can be determined.

In Polyethylene-Base Resin II, the amount X (% by mass) of ODCB-soluble portion at 25° C., the density d (g/cm³) and the MFR (g/10 min) have the following relationship:

i) in the case of d-0.008 logMFR≧0.93, X is less than 2% by mass, preferably less than 1% by mass, and

ii) in the case of d-0.008 logMFR<0.93, X has a relationship of X<9.8×10³×(0.9300−d+0.008 logMFR)²+2.0, preferably X<7.4×10³×(0.9300−d+0.008 logMFR)²+1.0, more preferably X<5.6×10³×(0.9300−d+0.008 logMFR)²+0.5. Here, the density d and the MFR in the right side of the inequality above are a numerical value without respective units. Accordingly, the amount X (% by mass) of the ODCB-soluble portion at 25° C. must be smaller than the value obtained by substituting only the values of density d and MFR of Polyethylene-Base Resin II into the formula in the right side of the inequality.

The ODCB-soluble portion at 25° C. includes a high branching degree component and a low molecular weight component mainly contained in the polyethylene-base resin. This portion causes a problem in the hygiene or blocking on the inner surface of a formed article and therefore, the content thereof is preferably small. The amount of ODCB-soluble portion is affected by the content and the molecular weight of comonomer. Accordingly, when the density, MFR and the amount of ODCB-soluble portion as indices satisfy the above-described relationship, this means less partiality of the copolymerization component (α-olefin) contained in the entire resin. In the present invention, when Polyethylene-Base Resin II satisfies the above-described relationship regarding the ODCB-soluble portion, the heat resistance, hygiene property and blocking resistance are improved and therefore, this is preferred.

(h) Cb

In Polyethylene-Base Resin II, the parameter Cb of the composition distribution is less than 2.00.

The method for measuring the parameter Cb of the composition distribution is described below. In o-dichlorobenzene (ODCB) having added thereto an antioxidant, a sample is dissolved under heating at 135° C. to have a sample concentration of 0.2% by mass. This solution is transferred to a column filled with diatomaceous earth (Celite 545) and cooled to 25° C. at a rate of 1° C./min, thereby depositing the sample on the surface of Celite. While flowing ODCB into this column at a constant flow rate, the column temperature is elevated stepwise to 130° C. in increments of 5° C. to elute and thereby fractionate the sample. Subsequently, methanol is mixed with the eluate and the sample reprecipitated is filtered and dried to obtain fraction samples at respective elution temperatures. The mass fraction and the branching degree (the number of branches per 1,000 carbon atoms) of the eluted sample at each temperature are determined by an isotopic carbon nuclear magnetic resonance apparatus (¹³C-NMR).

The branching degrees of the fractions at 30 to 90° C. are corrected as follows. The measured branching degrees are plotted with respect to the elution temperature and the correlation is approximated to a straight line by the least square and thereby, a calibration curve is configured. The coefficient of correlation in this approximation is sufficiently large. The value determined from this calibration curve is designated as the branching degree of each fraction. As for the components at elution temperatures of 95° C. or more, the linear relation is not necessarily established between the elution temperature and the branching degree and therefore, the values found are used without performing this correction.

Subsequently, the mass fraction wᵢ of each fraction is divided by the variation (bᵢ-bᵢ₋₁) in the branching degree bᵢ per the elution temperature of 5° C. to determine the relative concentration Cᵢ, and the determined relative concentrations are plotted with respect to the branching degree to obtain a composition distribution curve. This composition distribution curve is divided into fixed widths and the composition distribution parameter Cb is calculated according to the following formula:

$$Cb = ( \frac{\sum {C}_{j} {b}_{j}^{2}}{\sum {C}_{j} {b}_{j}} ) / ( \frac{\sum {C}_{m} {b}_{j}}{\sum {C}_{j}} )$$

wherein Cⱼ and bⱼ each independently represents the relative concentration and the branching degree of the j-th fraction. In the case where the sample composition is uniform, the composition distribution parameter Cb is 1.0. As the composition distribution is more widened, the value becomes larger.

The composition distribution parameter Cb of Polyethylene-Base Resin II used in the present invention is less than 2.00, preferably from 1.04 to 2.00. If the Cb is 2.00 or more, the blocking resistance is low and the heat seal properties are defective. Furthermore, the bleeding out of low molecular weight components and the like to the resin surface readily takes place and this causes a problem in hygiene.

Examples of Polyethylene-Base Resin II include ethylene•α-olefin copolymer. The α-olefin is an α-olefin having from 3 to 20 carbon atoms, preferably from 3 to 12 carbon atoms. Specific examples thereof include propylene, butene-1, 4-methylpentene-1, hexene-1, octene-1, decene-1 and dodecene-1. One or more of these α-olefins can be used. The content of α-olefin in the copolymer is usually 30 mol % or less, preferably 20 mol % or less.

Production process of Polyethylene-Base Resin II

The production process of Polyethylene-Base Resin II is not particularly limited and this resin may be produced by any method insofar as the above-described physical properties are satisfied, however, Polyethylene-Base Resin II is preferably obtained by copolymerizing ethylene with an α-olefin having from 3 to 20 carbon atoms in the presence of a catalyst which contains 0, 1 or 2 ligand(s) having a cyclopentadienyl skeleton and which contains a transition metal compound of Group IV of the Periodic Table as an essential component.

Polyethylene-Base Resin II is more preferably produced using a catalyst described below, however, the present invention is not limited thereto.

For example, a catalyst system comprising an organic transition catalyst having a transition metal selected from Group IV of the Periodic Table and containing 0, 1 or 2 cyclopentadienyl derivative(s), and a compound capable of reacting with the organic transition catalyst to form an ionic complex and/or an organic aluminum oxy compound can be used. In this catalyst system, an organic aluminum compound may also be used, if desired. Furthermore, the organic transition catalyst can also be used by mounting it on an inorganic compound, fine particle or the like, if desired.

The catalysts disclosed in the following patent publications can be used in the production, however, the present invention is not limited thereto. Examples of the catalyst which can be used include those disclosed in JP-A-11-293054, JP-A-11-310607, JP-A-8-309939, JP-A-10-77370, and the like.

(3) Resin Material (A)

The resin material (A) contains the above-described high-density polyethylene. The resin material (A) may comprise only the high-density polyethylene or may be a resin composition comprising the high-density polyethylene and Polyethylene-Base Resin II.

In the case of a resin composition, the ratio between the high-density polyethylene and Polyethylene-Base Resin II blended in the resin material (A) is such that the high-density polyethylene is from 40 to 99% by mass, preferably from 50 to 99% by mass, more preferably from 60 to 99% by mass. If the ratio of the high-density polyethylene blended is less than the above-described range, the impact strength of the seal part decreases and this is not preferred, whereas if the ratio blended exceeds the above-described range, the strength disadvantageously decreases.

In the present invention, particularly, when the inner layer is composed of a resin material having blended therein 50% by mass or more of a high-density polyethylene and thus mainly comprising the high-density polyethylene, surprisingly, not only the heat resistance is improved but also the heat seal property, in particular, the impact strength of the seal part is remarkably improved as compared with the case where the inner layer is composed of a resin material mainly comprising an ethylene•α-olefin copolymer having the above-described physical properties (e) to (h).

In the resin material (A), if desired, known additives commonly used may be appropriately blended within the range of not seriously impairing the effect of the present invention, such as antistatic agent, antioxidant, lubricant, anti-blocking agent, antifoggant, organic or inorganic pigment, ultraviolet absorber and dispersant.

II. Intermediate Layer

The intermediate layer in the laminate of the present invention is composed of a resin material (B) mainly comprising Polyethylene-Base Resin I having the following physical properties (a) to (d).

(1) Polyethylene-Base Resin I

(a) Density

The density of Polyethylene-Base Resin I is less than 0.920 g/cm³. If the density exceeds this range, the transparency and the flexibility disadvantageously decrease. The density is more preferably from 0.880 to 0.920 g/cm³, still more preferably from 0.890 to 0.918 g/cm³.

(b) MFR

The MFR of Polyethylene-Base Resin I is from 0.1 to 50 g/10 min. If the MFR is less than this range, the formability disadvantageously decreases, whereas if the MFR exceeds this range, the strength decreases. The MFR is more preferably from 0.1 to 10 g/10 min.

(c) ODCB-soluble Portion

In Polyethylene-Base Resin I, the amount X (% by mass) of ODCB-soluble portion at 25° C., the density d and the MFR satisfy a predetermined relationship. The ODCB-soluble portion at 25° C. can be determined by the above-described measuring method. The relationship in the amount X (% by mass) of the ODCB-soluble portion at 25° C., the density d (b/cm³) and the MFR (g/10 min) is as follows. These satisfy the relationship of X<9.8×10³×(0.9300−d+0.008 logMFR)²+2.0, preferably X<7.4×10³×(0.9300−d+0.008 logMFR)²+1.0, more preferably X<5.6×10³×(0.9300−d+0.008 logMFR)²+0.5. Here, the density d and the MFR in the right side of the inequality above are a numerical value without respective units. Accordingly, the amount X (% by mass) of the ODCB-soluble portion at 25° C. must be smaller than the value obtained by substituting only the values of density d and MFR of Polyethylene-Base Resin I into the formula in the right side of the inequality. In the present invention, when Polyethylene-Base Resin I satisfies the above-described relation regarding the ODCB-soluble portion, good results are obtained in the resistance, hygiene property and blocking resistance.

(d) Cb

The composition distribution parameter Cb of Polyethylene-Base Resin I is less than 2.00, preferably from 1.08 to 2.00. With a Cb in this range, high blocking resistance and excellent heat seal properties are attained. If the Cb is 2.00 or more, the blocking resistance is low and the heat seal property is defective. In addition, the bleeding out of low molecular weight components and the like to the resin surface readily occurs and this causes a problem in hygiene. The measuring method of the composition distribution parameter Cb is as described above.

Examples of Polyethylene-Base Resin I include ethylene•α-olefin copolymer. The α-olefin is an α-olefin having from 3 to 20 carbon atoms, preferably from 3 to 12 carbon atoms. Specific examples thereof include propylene, butene-1, 4-methylpentene-1, hexene-1, octene-1, decene-1 and dodecene-1. One or more of these α-olefins may be used. The content of α-olefin in the copolymer is usually 30 mol % or less, preferably 20 mol % or less.

(2) Preferred Polyethylene-Base Resin I

More preferred examples of Polyethylene-Base Resin I for use in the present invention include those satisfying the above-described physical properties (a) to (d) and additionally satisfying the physical properties (i) and (j) below.

(i) Mw/Mn

Polyethylene-Base Resin I preferred in the present invention has a molecular weight distribution (Mw/Mn) of 1.5 to 3.5, preferably from 2.0 to 3.0. With respect to the method for calculating Mw/Mn, a weight average molecular weight (Mw) and a number average molecular weight (Mn) are determined by gel permeation chromatography (GPC) and from the determined values, the ratio Mw/Mn is obtained. If the Mw/Mn is less than the above-described range, the formability is inferior, whereas if the Mw/Mn exceeds the above-described range, the impact resistance is poor.

(j) Peak on Elution Temperature-elution Amount Curve by TREF

Polyethylene-Base Resin I preferred in the present invention has a plurality of peaks on the elution temperature-elution amount curve by a continuous rising temperature elution fractionation method (TREF). More preferably, at least one of these peaks is preferably present between 85° C. and 100° C. By virtue of the presence of this peak, the heat resistance of the formed article is enhanced.

The measurement by TREF is performed as follows. In ODCB having added thereto an antioxidant, a sample is dissolved under heating at 135° C. to have a sample concentration of 0.05% by mass. Then, 5 ml of this sample solution is poured into a column packed with glass beads and cooled to 25° C. at a cooling rate of 0.1° C./min to deposit the sample on the surface of glass beads. Subsequently, while flowing ODCB through this column at a constant flow rate, the column temperature is elevated at a constant rate of 50° C./hour to elute the sample in sequence. At this time, the concentration of the sample eluted into a solvent is continuously measured by an infrared spectrometer having absorption at 2,925 cm⁻¹ which is the wave number in the asymmetric stretching vibration of methylene. From the value measured, the concentration of ethylene•α-olefin copolymer in the solution is quantitated and therefrom, the relationship between the elution temperature and the elution rate is obtained. In the TREF analysis, the change in the elution rate with respect to the change in the temperature can be continuously analyzed using a trace amount of sample and therefore, relatively fine peaks which cannot be detected by fractionation can be detected.

(3) Production Process of Polyethylene-Base Resin I

The production process of Polyethylene-Base Resin I is not particularly limited and this resin may be produced by any method insofar as the above-described physical properties are satisfied, however, Polyethylene-Base Resin I is preferably obtained by copolymerizing ethylene with an α-olefin having from 3 to 20 carbon atoms in the presence of a catalyst which contains 0, 1 or 2 ligand(s) having a cyclopentadienyl skeleton and which contains a transition metal compound of Group IV of the Periodic Table as an essential component.

Polyethylene-Base Resin I is more preferably produced using a catalyst described below, however, the present invention is not limited thereto.

For example, a catalyst system comprising an organic transition catalyst having a transition metal selected from Group IV of the Periodic Table and containing 0, 1 or 2 cyclopentadienyl derivative(s), and a compound capable of reacting with the organic transition catalyst to form an ionic complex, and/or an organic aluminum oxy compound can be used. In this catalyst system, an organic aluminum compound may also be used, if desired. Furthermore, the organic transition catalyst can also be used by mounting it on an inorganic compound, fine particle or the like, if desired.

Polyethylene-Base Resin I can be produced using a catalyst disclosed, for example, in the patent publications described above, however, the present invention is not limited thereto.

The polymerization may be performed by using any method of vapor phase method, slurry method and solution method. Also, the polymerization may be a single stage method or a multi-stage method.

(4) Resin Material (B)

The resin material (B) mainly comprises Polyethylene-Base Resin I, preferably comprises only Polyethylene-Base Resin I, however, resins other than Polyethylene-Base Resin I may be blended within the range of not impairing the effect of the present invention. Examples of the other resins include Polyethylene-Base Resin II, high-density polyethylene, medium-density polyethylene, high-pressure low-density polyethylene, linear low-density polyethylene, polypropylene, ethylene-propylene random copolymer and ethylene-propylene block copolymer. In the case of blending other resins, the ratio in percentage of Polyethylene-Base Resin I is suitably 50% by mass or more, preferably 60% by mass or more. If the ratio in percentage of Polyethylene-Base Resin I is less than 50% by mass, the strength disadvantageously decreases. In addition, among the other resins, resins having a density of 0.935 g/cm³ or greater are preferable, and resins having a density of 0.940 g/cm³ or greater are more preferable. These resins are preferable, because they improve heat resistance. Examples of these resins include resins which are selected from Polyethylene-Base Resin II, linear low-density polyethylene, and high-density polyethylene, and which have a density of 0.935 g/cm³ or greater. In particular, high-density polyethylene having a density of 0.935 g/cm³ or greater is preferable.

In the resin material (B), if desired, known additives commonly used may be appropriately blended within the range of not seriously impairing the effect of the present invention, such as antistatic agent, antioxidant, lubricant, anti-blocking agent, antifoggant, organic or inorganic pigment, ultraviolet absorber and dispersant.

III. Outer Layer

The outer layer in the laminate of the present invention comprises a resin material (C) containing a high-density polyethylene. The resin material (C) may comprise only a high-density polyethylene or may comprise a resin composition obtained by blending the high-density polyethylene and/or high-pressure low-density polyethylene with Polyethylene-Base Resin II constituting the inner layer and having the physical properties (e) to (h).

These high-density polyethylene and Polyethylene-Base Resin II can be selected from those described above as the resin which can be used as the high-density polyethylene and Polyethylene-Base Resin II constituting the inner layer.

In the case of using the resin composition comprising a high-density polyethylene and Polyethylene-Base Resin II for the outer layer, the blending ratio in percentage is such that Polyethylene-Base Resin II is from 5 to 95% by mass, preferably from 15 to 85% by mass, more preferably from 30 to 70% by mass. If the blending ratio in percentage of Polyethylene-Base Resin II is less than the above-described range, the strength disadvantageously decreases, whereas if the blending ratio in percentage exceeds the above-described range, the blocking may disadvantageously take place.

When the outer layer comprises the resin composition obtained by blending the high-density polyethylene and high-pressure low-density polyethylene, the ratio in percentage of high-pressure low-density polyethylene is suitably from 5 to 95% by weight, preferably from 15 to 85% by weight, more preferably from 30 to 75% by weight. If the ratio in percentage of high-pressure low-density polyethylene is in such range, formability is improved, and inferior appearance, such as wrinkles, rarely occur. The outer layer thereby has a good appearance.

The outer layer may also be composed of a heat-resistant resin material (D) having a melting point peak temperature of 130° C. or more as measured by differential scanning calorimeter (DSC). In the case where a plurality of peaks are present, the highest temperature peak is 130° C. or more. Examples of the resin material (D) include medium-density polyethylene, polypropylene, ethylene-propylene random copolymer, ethylene-propylene block copolymer, ethylene-vinyl alcohol copolymer (EVOH), polyamide such as 6-nylon and 6,6-nylon, and polyester such as polyethylene terephthalate and polybutylene terephthalate.

In the resin materials (C) and (D) constituting the outer layer, if desired, known additives commonly used may be appropriately blended within the range of not seriously impairing the effect of the present invention, such as antistatic agent, antioxidant, lubricant, anti-blocking agent, antifoggant, organic or inorganic pigment, ultraviolet absorber and dispersant.

IV. Laminate

(1) Layer Structure

The layer structure in the laminate of the present invention is not particularly limited insofar as the laminate has an inner layer, an intermediate layer and an outer layer (the inner layer is a heat seal layer) in this order. As for the number of layers, a three-layer structure consisting of outer layer/intermediate layer/inner layer is most preferred, however, the present invention is not limited thereto. A layer structure where an additional layer is provided in the intermediate layer of the outer layer/intermediate layer/inner layer structure, namely, outer layer/intermediate layer/middlemost layer/intermediate layer/inner layer, may be employed or another layer may be appropriately provided, if desired, between outer layer and intermediate layer or between intermediate layer and inner layer. Examples of these other layers include adhesive layer, gas barrier layer and ultraviolet ray absorbing layer. For example, a five-layer structure such as outer layer/gas barrier layer/intermediate layer/adhesive layer/inner layer may also be employed. In addition, a layer may further be newly provided in the outer side of the outer layer.

Examples of the adhesive constituting the adhesive layer include polyurethane-base adhesive, vinyl acetate adhesive, hot melt adhesive and adhesive resins such as maleic anhydride-modified polyolefin and ionomer resin. In the case of incorporating an adhesive layer into the layer structure, this layer may be laminated by co-extruding essential constituent layers such as inner layer and intermediate layer together with this adhesive.

The layer structure of the present invention is most preferably a structure of inner layer/intermediate layer/outer layer=high-density polyethylene/resin composition obtained by blending Polyethylene-Base Resin I having physical properties (a) to (d) and (i) and (j) and Polyethylene-Base Resin II having physical properties (e) to (h)/resin composition obtained by blending high-density polyethylene and Polyethylene-Base Resin II having physical properties (e) to (h).

By employing this layer structure, surprisingly, the heat resistance and the seal part impact strength are remarkably improved. This is an effect brought out particularly when this specific layer structure is employed, and this effect cannot be obtained when Polyethylene-Base Resin II having physical properties (e) to (h) is used alone as the resin material constituting the inner layer. The reasons why such an effect is brought out are not necessarily clarified, however, it is considered that the physical properties (strength) of not only the inner layer but also the intermediate layer and depending on the case, even the properties of the outer layer affect the strength of the seal part when the inner layer is heat sealed with each other. This effect obtained by the combination of layers composed of specific resin materials is neither described not suggested in conventional arts.

(2) Thickness of Each Layer

The entire thickness of the laminate of the present invention is not particularly limited and may be appropriately selected according to the end use, however, the entire thickness is preferably from 0.01 to 1 mm, more preferably from 0.1 to 0.5 mm. The entire thickness within the above-described range is advantageous in that high transparency and excellent flexibility are attained.

X The thickness ratio among respective layers is not particularly limited, however, the laminate is preferably constructed such that the low-density layer (the intermediate layer) using the resin material having a density of 0.920 g/cm³ or less works out to a main layer in view of the thickness. The thickness ratio among these layers are more preferably on the order of inner layer:intermediate layer:outer layer=1 to 30:40 to 98:1 to 30 (thickness ratio) (provided that the total thickness of all layers is 100).

(3) Method for Producing Laminate

The production method for the laminate of the present invention is not particularly limited, however, examples thereof include a method of forming the laminate film or sheet by water-cooling or air-cooling co-extrusion multi-layer inflation, co-extrusion multi-layer T-die casting, dry lamination or extrusion lamination. Among these, preferred are water-cooling co-extrusion multilayer inflation method and co-extrusion multilayer T-die casting method. Particularly, use of water-cooling co-extrusion multi-layer inflation method is advantageous in many points such as transparency and hygiene. In addition, a multilayer blow molding product may also be formed by multilayer blow molding process.

The laminate film or sheet may be further processed into a bag by heat-sealing or the multilayer blow molding product may be used as it is or may be used as a container after fixing a cap or the like. In particular, the laminate of the present invention is preferably worked into a bag shape by heat-sealing at least one part of a laminate film or sheet using the inner layer as a heat-seal layer.

V. Uses

Particularly when the laminate of the present invention is worked into a bag shape by heat-sealing the inner layer as a heat-seal layer, the impact strength of the heat-seal part after sealing the heat-seal part at a temperature of 155° C. can be as high as 700 kJ/m² or more, further 800 kJ/m² or more, still further 900 kJ/m² or more.

Also, the laminate of the present invention can maintain high impact strength of the seal part even after a heat treatment necessary particularly for medical or food container and the like is performed, such as sterilization. More specifically, for example, when a sterilization treatment is performed (121° C., 20 min), the seal part impact strength after the sterilization treatment is as high as 500 kJ/m² or more, further 600 kJ/m² or more, still further 700 kJ/m² or more.

The seal part impact strength as used herein is a value when the heat sealing is performed under the heat sealing conditions such that the sealing temperature is 155° C., the sealing time is 5 seconds and the sealing pressure is 0.4 MPa.

As such, the container comprising the laminate of the present invention can maintain high seal part strength even after the heat-treatment such as sterilization. Accordingly, this container is suitable for medical containers, food containers such as retort pouch, and the like, which are required to have high seal part strength also after the sterilization treatment. In particular, this container can be suitably used for medical containers such as medical transfusion bag, more specifically, blood bag, platelet storing bag, transfusion (liquid medicament) bag, multiple-compartment medical container (where two or more kinds of liquid medicaments are stored in separate compartments partitioned by an adhesive part and these multiple liquid medicaments are mixed in a closed state by peeling off the adhesive part on use), artificial dialysis bag and the like.

### EXAMPLES

The present invention is described in greater detail below by referring to Examples, however, the present invention is not limited to these Examples. In Examples and Comparative Examples, the physical properties were evaluated by the following methods.

(1) MFR: MFR was measured in accordance with JIS-K6760.

(2) Density: The density was measured in accordance with JIS-K6760.

(3) ODCB-soluble portion

In 20 ml of ODCB, 0.5 g of a sample was heated at 135° C. for 2 hours and after the sample was completely dissolved, the solution was cooled to 25° C. This solution was left standing at 25° C. over night and then filtered by a Teflon-made filter. The filtrate was sampled and using this filtrate, the absorption peak area near the wave number of 2,925 cm⁻¹, which is an asymmetric stretching vibration of methylene, was determined by means of an infrared spectrometer. Based on the value obtained, the sample concentration was calculated from the previously prepared calibration curve. From this value, the ODCB-soluble portion at 25° C. was determined.

(4) Cb

In o-dichlorobenzene (ODCB) having added thereto an antioxidant (2,6-Di-t-Butyl-p-Cresol, 0.1% by weight), a sample was dissolved under heating at 135° C. to have a sample concentration of 0.2% by mass. This solution was transferred to a column filled with diatomaceous earth (Celite 545) and cooled to 25° C. at a rate of 0.1° C./min, thereby depositing the sample on the surface of Celite. While flowing ODCB into this column at a rate of 1 ml/min, the column temperature was elevated stepwise to 120° C. in increments of 5° C. to elute and thereby fractionate the sample. Subsequently, methanol was mixed with the eluate and the sample reprecipitated was filtered and dried to obtain fraction samples at respective elution temperatures. The mass fraction and the branching degree (the number of branches per 1,000 carbon atoms) of the eluted sample at each temperature were determined by ¹³C-NMR. Subsequently, the mass fraction wᵢ of each fraction was divided by the variation (bᵢ-bᵢ₋₁) in the branching degree bᵢ per the elution temperature of 5° C. to determine the relative concentration Cᵢ, and the determined relative concentrations are plotted with respect to the branching degree to obtain a composition distribution curve. This composition distribution curve was divided into fixed widths and the composition distribution parameter Cb was calculated according to the formula shown above.

(5) Mw/Mn

A weight average molecular weight (Mw) and a number average molecular weight (Mn) were determined by gel permeation chromatography (GPC) and from the determined values, the ratio Mw/Mn was obtained. The detailed conditions were as follows.

GPC: Model 150 type, produced by Waters

Eluting solvent: ODCB

Column Temperature: 135° C.

Column: GMMHR-H(S), produced by Tosoh Corporation

(6) Number of peaks by TREF

In ODCB having added thereto an antioxidant (2,6-Di-t-Butyl-p-Cresol, 0.1% by weight), a sample was dissolved under heating at 135° C. to have a sample concentration of 0.05% by mass. Then, 5 ml of this sample solution was poured into a column packed with glass beads and cooled to 25° C. at a cooling rate of 0.1° C./min to deposit the sample on the surface of glass beads. Subsequently, while flowing ODCB through this column at a rate of 1 ml/min, the column temperature was elevated at a constant rate of 50° C./hour to elute the sample in sequence. At this time, the concentration of the sample eluted into a solvent was continuously measured by an infrared spectrometer having absorption at 2,925 cm⁻¹ which was the wave number in the asymmetric stretching vibration of methylene. Moreover, as the infrared spectrometer, a Cross fractionation chromatography (marketed by Mitsubishi Chemical Corporation). From the value measured, the concentration of ethylene•α-olefin copolymer in the solution was quantitated and therefrom, the relationship between the elution temperature and the elution rate was obtained. From the values obtained, an elution temperature-elution amount curve was configured and the number of peaks was counted.

(7) Seal part impact strength

Using the inner layer as the heat seal layer, heat sealing was performed under the conditions such that the pressure was 0.4 MPa, the sealing temperature was 155° C. and the sealing time was 5 seconds. The resulting seal part was punched into an s-type test shape used in the tensile and impact test method (ASTM-D 1822) such that the seal interface came to the center. After the sterilization treatment (121° C., 20 minutes), the seal part was opened like a T shape separated by the seal interface and measured at 23° C. by a tensile and impact tester.

(8) Blocking resistance

Two sheets of films each cut into a 20 mm-width strip were superposed only in the length of 5 cm and thereon, a weight of 10 kg was placed. After allowing these sheets to stand in an oven kept at 50° C. for 48 hours, the conditions were adjusted at 23° C. and two sheets of films were peeled apart from each other. The peeled surface was observed with an eye.

◯: The surface was not clouded.

x: The surface was clouded.

(9) Heat resistance

A film having a length of 20 cm and a width of 20 cm was cut, the three sides were sealed, water was poured into the inside thereof, and the last one side was sealed to produce a bag of which the all four sides were sealed. After sterilization at 121° C. for 20 minutes, the outer appearance was evaluated with an eye.

⊚: No deformation and no wrinkling.

◯: No deformation but slight wrinkling.

x: Deformed and many wrinkles.

### Examples 1 to 12 and Comparative Examples 1 to 3

The laminate film comprising an inner layer, an intermediate layer and an outer layer each composed of the resin shown in Table 1 was produced by water-cooling co-extrusion multi-layer inflation. The thickness of each layer from the inner layer was set to 10 μm/225 μm/15 μm. The measurement results of heat resistance, blocking resistance and seal part impact strength are shown in Table 2.

The resins used in Examples and Comparative Examples are described below.

(1) s-LL1: Ethylene•hexene-1 copolymer (density: 0.898 g/cm³, MFR: 1.0 g/10 min, Mw/Mn: 2.7) produced using a single site-type catalyst

(2) s-LL2: Ethylene•hexene-1 copolymer (density: 0.905 g/cm³, MFR: 1.2 g/10 min, Mw/Mn: 2.8) produced using a single site-type catalyst

(3) s-LL3: Ethylene•hexene-1 copolymer (density: 0.901 g/cm³, MFR: 0.8 g/10 min, Mw/Mn: 2.3) produced using a single site-type catalyst

(4) s-LL4: Ethylene•hexene-1 copolymer (density: 0.924 g/cm³, MFR: 2.1 g/10 min, Mw/Mn: 2.6) produced using a single site-type catalyst

(5) s-LL5: Ethylene•hexene-1 copolymer (density: 0.942 g/cm³, MFR: 1.2 g/10 min, Mw/Mn: 2.2) produced using a single site-type catalyst

(6) HD1: High-density polyethylene (density: 0.945 g/cm³, MFR: 2.8 g/10 min)

(7) HD2: High-density polyethylene (density: 0.952 g/cm³, MFR: 3.5 g/10 min)

(8) LD1: High-pressure low-density polyethylene (density: 0.927 g/cm³, MFR: 1.5 g/10 min)

(9) PP1: Propylene•ethylene random copolymer (density: 0.900 g/cm³, MFR: 4.0 g/10 min)

(10) PP2: Propylene•ethylene block copolymer (density: 0.900 g/cm³, MFR: 2.5 g/10 min)

TABLE 1

| | | | ODCB- | | | | | |
|---|---|---|---|---|---|---|---|---|
| | | | Soluble | | | | | |
| | MFR | Den- | Portion | | | | | TREF |
| | (g/10 | sity | (% by | | | | Mw/ | Peak |
| | min.) | (g/cm³) | mass) | (c)¹⁾ | (g)²⁾ | Cb | Mn | Number |
| s-LL1 | 1.0 | 0.898 | 11.6 | 12.0 | 12.0 | 1.40 | 2.7 | plural |
| s-LL2 | 1.2 | 0.905 | 3.4 | 8.4 | 8.4 | 1.35 | 2.8 | plural |
| s-LL3 | 0.8 | 0.901 | 3.1 | 9.8 | 9.8 | 1.10 | 2.3 | singular |
| s-LL4 | 2.1 | 0.924 | 0.8 | 2.7 | 2.7 | 1.20 | 2.4 | plural |
| s-LL5 | 1.2 | 0.942 | 0.4 | 3.3 | 2.0 | 1.15 | 2.5 | singular |
| HD1 | 2.8 | 0.945 | — | | | — | — | — |
| HD2 | 3.5 | 0.952 | — | | | — | — | — |
| LD1 | 1.5 | 0.927 | — | | | — | — | — |
| PP1 | 4.0 | 0.900 | — | | | — | — | — |
| PP2 | 2.5 | 0.900 | — | | | — | — | — |

In the Table 1,

1) denotes X value indicated by the following formula:

X=9.8×10³×(0.9300−d+0.008 logMFR)²+2.0

wherein the density is denoted by d (g/cm³), and the MFR is denoted by MFR (g/10 min), and

2) denotes X value indicated by the following formula:

in the case of d-0.008 logMFR≧0.93, X<2.0, and

in the case of d-0.008 logMFR<0.93, X<9.8×10³×(0.9300−d+0.008 logMFR)²+2.0

wherein the density is denoted by d (g/cm³), and the MFR is denoted by MFR (g/10 min).

TABLE 2

| | | | | Heat | Blocking | Seal Part Impact |
|---|---|---|---|---|---|---|
| | Inner Layer | Intermediate Layer | Outer Layer | Resistance | Resistance | Strength (kJ/m²) |
| Example 1 | HD2 | s-LL1 | HD2 | ◯ | ◯ | 1200 |
| Example 2 | HD2/s-LL4 = 90/10 | s-LL2 | HD1 | ◯ | ◯ | 1000 |
| Example 3 | HD2 | s-LL2/s-LL5 = 90/10 | HD2/s-LL5 = 30/70 | ⊚ | ◯ | 850 |
| Example 4 | HD2 | s-LL1/s-LL5 = 70/30 | HD2/s-LL5 = 50/50 | ⊚ | ◯ | 1100 |
| Example 5 | HD1/s-LL4 = 40/60 | s-LL2 | HD1/s-LL5 = 50/50 | ◯ | ◯ | 880 |
| Example 6 | HD1 | s-LL2/s-LL4 = 60/40 | PP1 | ◯ | ◯ | 600 |
| Example 7 | HD1 | s-LL3/s-LL5 = 70/30 | HD1/s-LL5 = 70/30 | ◯ | ◯ | 950 |
| Example 8 | HD2 | s-LL2 | PP2 | ◯ | ◯ | 650 |
| Example 9 | HD2 | s-LL2/HD2 = 90/10 | HD2 | ◯ | ◯ | 900 |
| Example 10 | HD2/s-LL4 = 90/10 | s-LL2/HD2 = 90/10 | HD2/s-LL5 = 30/70 | ◯ | ◯ | 890 |
| Example 11 | HD2 | s-LL2/HD2 = 90/10 | HD2/LD1 = 30/70 | ◯ | ◯ | 850 |
| Example 12 | HD2 | s-LL2/HD2 = 85/15 | HD2/s-LL5 = 30/70 | ◯ | ◯ | 750 |
| Comparative | LD1 | s-LL2 | LD1 | X | ◯ | 550 |
| Example 1 | | | | | | |
| Comparative | HD1 | s-LL3 | LDl | X | ◯ | 500 |
| Example 2 | | | | | | |
| Comparative | s-LL4/HD2 = 95/5 | s-LL2/s-LL4 = 70/30 | HD2 | ◯ | ◯ | 200 |
| Example 3 | | | | | | |

Film thickness: 250 μm

Inner layer/intermediate layer/outer layer=10 μm/225 μm/15 μm

### INDUSTRIAL APPLICABILITY

As described in the foregoing pages, the laminate of the present invention can maintain high seal part strength even after the heat treatment such as sterilization. Accordingly, this is suitable for use in medical container, food container such as retort pouch, and the like, which are required to have high seal part strength also after the sterilization treatment. In particular, this can be suitably used for medical containers such as medical transfusion bag, more specifically, blood bag, platelet storing bag, transfusion (liquid medicament) bag, multiple-compartment medical container (where two or more kinds of liquid medicaments are stored in separate compartments partitioned by an adhesive part and these multiple liquid medicaments are mixed in a closed state by peeling off the adhesive part on use), artificial dialysis bag and the like.

1. A laminate having at least an inner layer, an intermediate layer and an outer layer, wherein said inner layer comprises a resin material (A) containing a high-density polyethylene, said intermediate layer comprises a resin material (B) mainly comprising Polyethylene-Base Resin I which is an ethylene•α-olefin copolymer obtained by copolymerizing ethylene with an α-olefin having from 3 to 20 carbon atoms and which has the following physical properties (a) to (d), and said outer layer comprises a resin material (c) containing a high-density polyethylene:
(a) the density is less than 0.920 g/cm³,
(b) the MFR is from 0.1 to 50 g/10 min,
(c) the amount X (% by mass) of o-dichlorobenzene-soluble portion at 25° C., the density d (g/cm³) and the MFR (g/10 min) satisfy the following relationship:
X<9.8×10³×(0.9300−d+0.008 logMFR)²+2.0
(d) the parameter Cb of the composition distribution is from 1.08 to 2.00.

2. The laminate as claimed in claim 1, wherein said resin material (A) constituting said inner layer comprises only a high-density polyethylene.

3. The laminate as claimed in claim 1, wherein said resin material (A) constituting said inner layer is a resin composition obtainable by blending a high-density polyethylene with Polyethylene-Base Resin II which is an ethylene•α-olefin copolymer obtained by copolymerizing ethylene and an α-olefin having from 3 to 20 carbon atoms and which has the following physical properties (e) to (h):
(e) the density is 0.920 to less than 0.960 g/cm³,
(f) the MFR is from 0.1 to 50 g/10 min,
(g) the amount X (% by mass) of o-dichlorobenzene-soluble portion at 25° C., the density d (g/cm³) and the MFR (g/10 min) satisfy the following relationship:
i) in the case of d-0.008 logMFR≧0.93, X<2.0, and
ii) in the case of d-0.008 logMFR<0.93,
X<9.8×10³×(0.9300−d+0.008 logMFR)²+2.0
and
(h) the parameter Cb of the composition distribution is less than 2.00.

4. The laminate as claimed in claim 3, wherein said α-olefin described in claim 3 is one or more members selected from the group consisting of propylene, butene-1, 4-methylpentene-1, hexene-1, octene-1, decene-1 and dodecene-1.

5. The laminate as claimed in claim 3, wherein in said ethylene•α-olefin copolymer constituting Polyethylene-Base Resin II, the content of said α-olefin in said copolymer is 30 mol % or less.

6. The laminate as claimed in claim 3, wherein said resin material (A) constituting said inner layer is a resin composition obtained by blending from 40 to 99% by mass of said high-density polyethylene and from 60 to 1% by mass of said Polyethylene-Base Resin II.

7. The laminate as claimed in claim 1, wherein said high-density polyethylene of said resin material (A) constituting said inner layer has an MFR of 0.1 to 20 g/10 min and a density of 0.940 to 0.970 g/cm³.

8. The laminate as claimed in claim 1, wherein said resin material (B) constituting said intermediate layer comprises only Polyethylene-Base Resin I.

9. The laminate as claimed in claim 1, wherein said α-olefin described in claim 1 is one or more members selected from the group consisting of propylene, butene-1, 4-methylpentene-1, hexene-1, octene-1, decene-1 and dodecene-1.

10. The laminate as claimed in claim 1, wherein said Polyethylene-Base Resin I satisfies said physical properties (a) to (d) and at the same time, has the following physical properties (i) and (j):
(i) Mw/Mn is from 1.5 to 3.5, and
(j) a plurality of peaks are present on the elution temperature-elution amount curve by continuous temperature rising elution fractionation (TREF).

11. The laminate as claimed in claim 1, wherein said resin material (B) constituting said intermediate layer is a resin composition obtained by blending said Polyethylene-Base Resin I and said Polyethylene-Base Resin II.

12. The laminate as claimed in claim 1, wherein said resin material (B) constituting said intermediate layer is a resin composition obtained by blending from 50 to 99% by mass of said Polyethylene-Base Resin I and from 50 to 1% by mass of said Polyethylene-Base Resin II.

13. The laminate as claimed in claim 1, wherein resin resin material (B) constituting said intermediate layer is a resin composition obtained by blending Polyethylene-Base Resin I with at least one member selected from the group consisting of high-density polyethylene, medium-density polyethylene, high-pressure low-density polyethylene, linear low-density polyethylene, polypropylene, ethylene-propylene random copolymer and ethylene-propylene block copolymer.

14. The laminate as claimed in claim 1, wherein said resin material (B) constituting said intermediate layer is a resin composition obtained by blending Polyethylene-Base Resin I with a resin having the density of 0.935 g/cm³ or greater.

15. The laminate as claimed in claim 1, wherein said resin material (C) constituting said outer layer comprises only a high-density polyethylene.

16. The laminate as claimed in claim 1, wherein said resin material (C) constituting said outer layer is a resin composition obtained by blending a high-density polyethylene and Polyethylene-Base Resin II which is an ethylene•α-olefin copolymer obtained by copolymerizing ethylene and an α-olefin having from 3 to 20 carbon atoms and which has the following physical properties (e) to (h):
(e) the density is 0.920 to less than 0.960 g/cm³,
(f) the MFR is from 0.1 to 50 g/10 min,
(g) the amount X (% by mass) of o-dichlorobenzene-soluble portion at 25° C., the density d (g/cm³) and the MFR (g/10 min) satisfy the following relationship:
i) in the case of d-0.008 logMFR≧0.93, X<2.0, and
ii) in the case of d-0.008 logMFR<0.93,
X<9.8×10³×(0.9300−d+0.008 logMFR)²+2.0
and
(h) the parameter Cb of the composition distribution is less than 2.00.

17. The laminate as claimed in claim 1, wherein said resin material (C) constituting said outer layer is a resin composition obtained by blending from 95 to 5% by mass of said high-density polyethylene and from 5 to 95% by mass of said Polyethylene-Base Resin II.

18. The laminate as claimed in claim 1, wherein said outer layer comprises a resin material (D) comprising a heat-resistant resin material having a melting point peak temperature of 130° C. or more as measured by differential scanning calorimeter (DSC).

19. The laminate as claimed in claim 18, wherein said heat-resistant resin material constituting said resin material (D) is a resin composition having blended therein at least one member selected from the group consisting of medium-density polyethylene, polypropylene, ethylene-propylene random copolymer, ethylene-propylene block copolymer, ethylene-vinyl alcohol copolymer (EVOH), polyamide such as 6-nylon and 6,6-nylon, and polyester such as polyethylene terephthalate and polybutylene terephthalate.

20. The laminate as claimed in claim 1, wherein the thickness of the entire laminate is from 0.01 to 1 mm.

21. The laminate as claimed in claim 1, wherein the thickness ratio among respective layers is inner layer/intermediate layer/outer layer=30 to 1/40 to 98/30 to 1 (assuming that the sum total is 100).

22. A method for producing a laminate, comprising the step of:
a step in which said laminate claimed in claim 1 is obtained by a water-cooling co-extrusion multilayer inflation method or a co-extrusion multilayer T-die casting method.

23. A container comprising said laminate claimed in claim 1.

24. The container as claimed in claim 23, wherein at least a part of said inner layer of the laminate is heat-sealed as a heat-seal layer.

25. The container as claimed in claim 23, wherein said inner layer of said laminate is worked into a bag shape by heat-sealing the inner layers at four sides as a heat seal layer.
